(19) United States
(12) Patent Application Publication
(10) Pub. No.: US 2009/0100148 A1
(43) Pub. Date: Apr. 16, 2009

(54) ELECTRONIC DEVICE WITH END-TO-END FLOW CONTROL OF MESSAGES

(75) Inventors: Srinivasan Murali, Chennai (IN); Martijn Franciscus Agnes Coenen, Eindhoven (NL); Andrei Radulescu, Eindhoven (NL); Kees Gerard Willem Goossens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/298,146

(22) PCT Filed: Apr. 17, 2007
(86) PCT No.: PCT/IB07/51361

§ 371 Date: Oct. 23, 2008

(30) Foreign Application Priority Data
Apr. 24, 2006 (EP) 06300395.8

(51) Int. Cl. G06F 15/16

(52) U.S. Cl. 709/218

(57) ABSTRACT

An electronic device is provided which comprises at least one sender (S0-S3) for transmitting data and at least one receiver (R) for receiving data. Furthermore, a network-based interconnect (N) is provided for coupling the at least one sender and the at least one receiver such that a data traffic from the sender is forwarded to the receiver. In addition, at least one separate shared dedicated control interconnect (CI) is coupled between the at least one sender (S0-S3) and the at least one receiver (R) for communicating flow control data between the sender and the receiver.

The present invention relates to an electronic device, a method of end-to-end flow control and a data processing system.

Apart from bus-based communication systems, network-based interconnections for communication systems are used to transfer data between the different components of the communication system. Network-based communication systems may include a communication via the internet, an intranet, a communication between several boards, several chips in an electronic device (chip-to-chip interconnect) or a communication between several components on a single chip (on-chip networks). The networks may be based on a plurality of switches or routers which are coupled to each other for forwarding data. Within network-based communication systems, a flow control is required to control the data transfer between a transmitter and a receiver, i.e. an end-to-end flow control. An end-to-end flow control is required as the behavior of a receiver may not be fully known. To accommodate for different communication rates or data transfer rates between a transmitter and a receiver, a receiver may comprise buffers. These buffers may become full during a communication between a transmitter and a receiver. If such a buffer is full and further data is received from the transmitter, a decision is to be made whether this data is discarded or whether other data within the buffer is to be discarded.

The flow control ensures that only data is sent from the transmitter if there is sufficient space available in the buffers of the receiver. However, if a flow control is not implemented and the buffers of the receiver fill up, the data received after the buffers are full can be queued across the network, e.g. for best effort BE traffic. However, this could lead to a blocking of other traffic or streams across the network, either temporarily (congestion) or permanently (deadlock). Otherwise, the data received after the buffers are full can be dropped by the receiver, e.g. for best effort BE traffic and for guaranteed throughput GT traffic. Furthermore, this may also affect a message level traffic between a request and response transaction if data is queued in the network. The above-mentioned deadlocks may be avoided by separated virtual or physical networks for request and response transaction. Furthermore, independent master/slave (transmitters or receivers) pairs may still observe a deadlock, as the receiving of a request is coupled to the sending of a response, i.e. a cyclic dependency can be present on the shared buffers in the network.

An end-to-end flow control for a network-based communication may be implemented based on credits for the data transfer. In particular, each connection between a sender/source and a receiver/destination, i.e. each communication between a source/sender and a destination/receiver, is considered as a separated connection and therefore requires separate queues for the data transfer, i.e. separate buffers at the sender and the receiver. The available amount of buffers or buffer space in the receiver can be maintained and monitored at the sender by the usage of a credit counter. The sender or transmitter will only then transmit data if the receiver has sufficient space in its buffer to buffer the data to be transmitted. The actual credit values for the sender can be sent from the receiver by piggybacking the credit values on packets or they may be sent as separate packets if the communication within or across a network is based on packets.

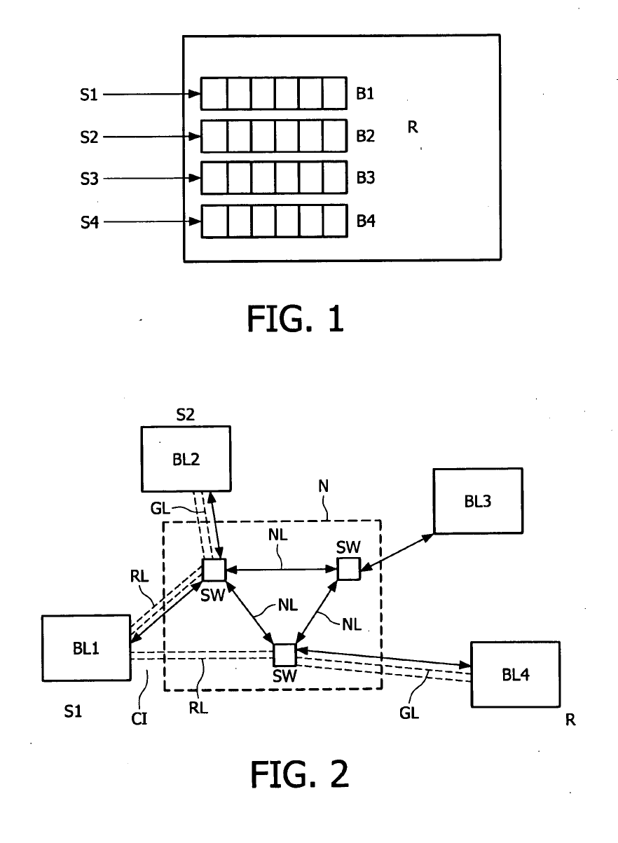

FIG. 1 shows a representation of a receiver within a network-based communication environment according to the prior art. Here, the receiver R comprises a buffer B for each of the senders. As four senders S1-S4 are present, the receiver must comprise four buffers B1-B4, wherein each buffer associated to the communication from one of the senders S1-S4.

If such an end-to-end flow control is implemented, every connection will require separate buffers at the receiver. If the buffers at the receiver are shared among the various connections across the network, the credit-based flow control would require that each sender must know when the other senders of the other connections are actually sending data to keep track of the available space in the buffers. However, spreading such information to all the senders within a few clock cycles is very difficult and complex. Therefore, typically the amount of buffering at the receiver will be large to accommodate for the separate buffers. Accordingly, such an implementation of an end-to-end flow control is expensive as a large hardware overhead is required.

U.S. Pat. No. 5,852,718 shows a centralized arbitration scheme for implementing an end-to-end flow control in a centralized manner. Here, communication can either be a packet-switched transaction or a circuit-switched transaction. The end-to-end flow control is implemented to avoid queue overflow and congestion conditions by prohibiting a master to send more transactions or data than the recipient has space for. In particular, a hardware handshake is used to signal the completion of a data transfer and to notify the master of available space in a queue.

It is therefore an object of the invention to provide an electronic device with a network-based communication of data which enables an end-to-end flow control with a reduced requirement for buffering.

This object is solved by an electronic device according to claim 1, a method for end-to-end flow control according to claim 11 and a data processing system according to claim 12.

Therefore, an electronic device is provided which comprises at least one sender for transmitting data and at least one receiver for receiving data. Furthermore, a network-based interconnect is provided for coupling the at least one sender and the at least one receiver such that a data traffic from the sender is forwarded to the receiver. In addition, at least one separate shared dedicated control interconnect is coupled between the at least one sender and the at least one receiver for communicating flow control data between the sender and the receiver.

Accordingly, as the flow control traffic is separated from the data traffic, the flow control traffic will not affect the data traffic. Furthermore, as the data and the flow control traffic is separated, the flow control traffic can be implemented on a separate control interconnect which is implemented in a dedicated shared version such that the flow control traffic will not have to be transmitted over the network-based interconnect.

According to an aspect of the invention, the control interconnect comprises at least a request line for request signals and at least a grant line for grant signals. Therefore, the request signals as well as the grant signals will each have a dedicated line which simplifies the flow control.

According to a preferred aspect of the invention, the network-based interconnect comprises a plurality of switches which are coupled by a plurality of network lines. The at least one request line and the at least one grant line are provided in addition to the network lines. Therefore, the request lines and the grant lines may be arranged in a similar fashion as the network lines.

According to a further aspect of the invention, the control interconnect is adapted to the structure of the network-based interconnect such that the control interconnect extends to the network-based interconnect from the at least one sender to the at least one receiver.

The invention also relates to a method for end-to-end flow control in an electronic device which comprises a sender and a receiver being coupled by a network-based interconnect. Data is transmitted from the sender and is received by a receiver. A data traffic is enabled by the network-based interconnect from the sender to the receiver. Flow control data between the sender and the receiver is forwarded via a separate shared dedicated control interconnect which is coupled between the sender and the receiver.

The invention also relates to a data processing system which comprises at least one sender for transmitting data and at least one receiver for receiving data. Furthermore, a network-based interconnect is provided for coupling the at least one sender and the at least one receiver such that a data traffic from the sender is forwarded to the receiver. In addition, at least one separate shared dedicated control interconnect is coupled between the at least one sender and the at least one receiver for communicating flow control data between the sender and the receiver.

The invention relates to the idea to provide an electronic device with a network-based interconnect for transmitting and transferring data between a sender and at least one receiver. In addition, a shared interconnect, e.g. a bus-based interconnect, is provided between the at least one sender and the at least one receiver. The shared interconnect is only used to communicate the flow control information and not for the data transfer.

Preferably, the flow control is implemented based on a common shared medium which can be accessed by an arbitration at the master of the common shared medium. Such a master will have knowledge about the amount of buffering available at the receiver. This can be implemented by a handshake mechanism. Firstly, the sender sends a request and then receives an acknowledgement from the master that a data transfer can be initiated.

The invention furthermore relates to the idea to decouple the network used for transferring the data from the actual flow-control mechanism. The flow-control mechanism is implemented by a handshake mechanism (request/grant signals) between the sender and receiver to ensure that sufficient buffering is available at the receiver. Therefore, a network-based interconnection as well as a shared interconnect like a bus-based interconnect is present in the electronic device. A scalable interconnect is used for the data transfer while shared interconnects are used for the end-to-end flow control. As the handshake rate is rather low (only a single request and grant transmission for each transaction), the sharing of the control interconnect is possible. On the other hand, the actual data transferred in or by this transaction may comprise several packets which are transmitted via the network-based interconnect. Accordingly, only a single queue of buffers is required in the receiver which can be used for all senders.

If the request and grant signals of the handshake mechanism arc transferred as packets in the network-based interconnect, the hardware overhead including the wiring required for the flow control is minimal as no additional wiring will be required. However, if the request and grant signals are sent as packets over the network-based interconnect, the latency of such a transmission can be significant such that larger buffers are required. Furthermore, these flow control packets will increase the traffic in the network possibly resulting in a congestion and reducing the throughput of the network-based interconnect. On the other hand, if the request and grant signals of the handshake mechanism of the flow control arc transmitted based on separate point-to-point control interconnects, the latency problems as well as the reduced throughput of the network due to flow control packets will be reduced and the buffer sizes can be reduced as well. On the other hand, the actual number of physical wires will increase as a separate point-to-point control interconnect is required. As the wiring for the control interconnect should be modular, a set of lines which are shared across all senders (a control bus) will be preferred over point-to-point wires.

The advantages and embodiments of the invention are now described with more detail with reference to the drawings.

FIG. 1 shows a schematic representation of a receiver for a network-based interconnect according to the prior art,

FIG. 2 shows a block diagram of an electronic device with a network-based interconnect and a bus-based interconnect according to a first embodiment,

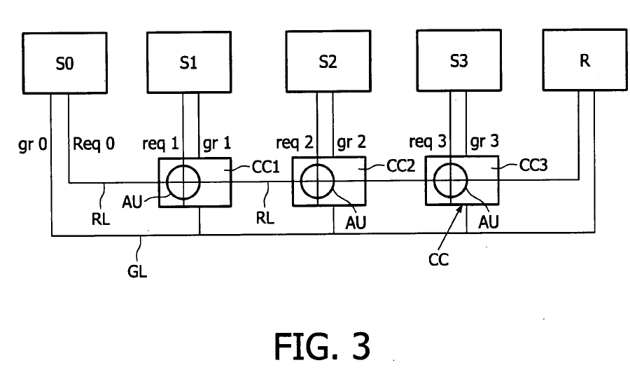

FIG. 3 shows a block diagram of an electronic device with a bus-based control interconnect according to a second embodiment,

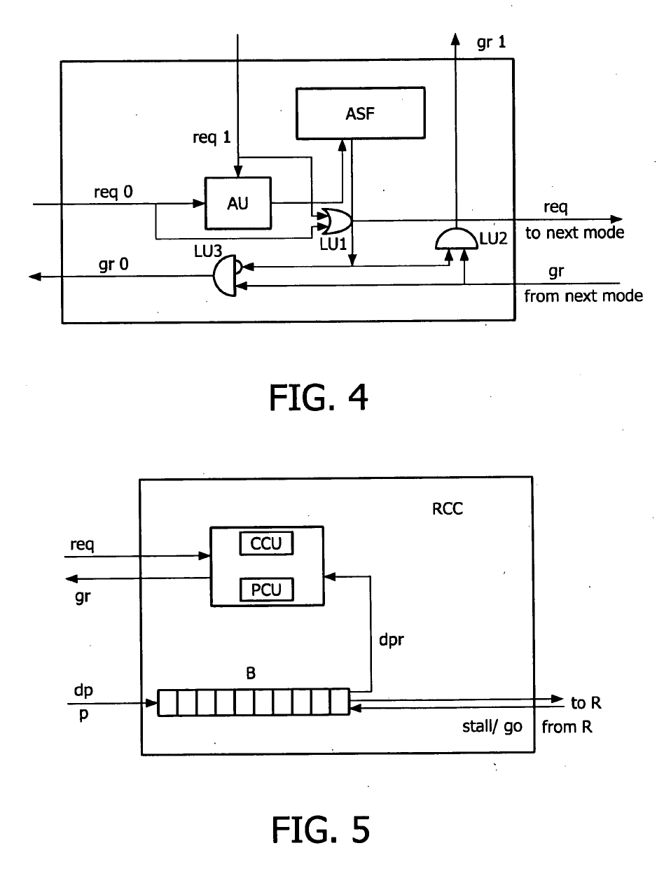

FIG. 4 shows a block diagram of a control circuit in a sender according to a third embodiment,

FIG. 5 shows a block diagram of a control circuit in a receiver according to a fourth embodiment,

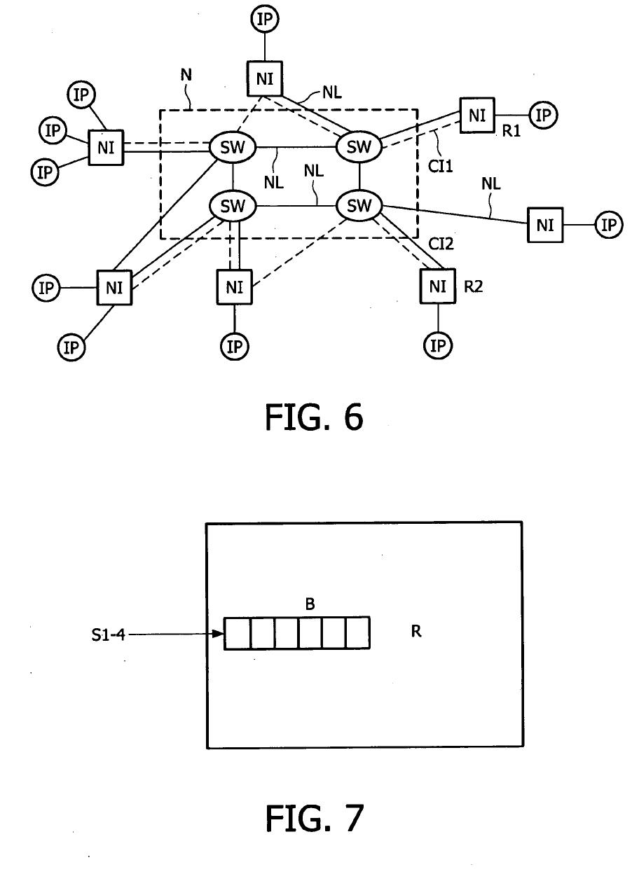

FIG. 6 shows a block diagram of a network-on-chip architecture according to a fifth embodiment, and

FIG. 7 shows a representation of a receiver according to a sixth embodiment.

FIG. 2 shows a block diagram of an electronic device with a network-based interconnect and a control interconnect according to a first embodiment. Here, four communication components or communication blocks BL1, BL2, BL3, BL4 are depicted. The communication components or communication blocks may refer to any processing unit which may include dedicated processors or a CPU. The communication components may also comprise intellectual property blocks which can implement a variety of applications or functions. The communication blocks BL1-BL4 are connected to a network N which comprises a plurality of switches SW or routers. The data communication between the communication blocks is performed over network lines and the switches SW. In addition to the network, a control interconnect CI is provided. In FIG. 2, two senders, namely S1, the communication block BL1 and a second sender S2, the communication block BL2 are depicted. These two senders S1, S2 communicate with a receiver R implemented as communication block BL4. The control interconnect CI comprises a request line RL and a grant line GL. The control interconnect CI is preferably implemented as two physical wires running from/to the senders S1, S2 and the receiver R. In particular, the senders S1, S2 communicate with the receiver R via a shared single request wire RL and a single grant wire GL covering the blocks BL1 and BL2. The request wire RL and the grant wire GL follow the switches SW in the network to simplify the backend design. However, while the data lines undergo an arbitration within the switches SW, the control lines can be bypassed around the switch logic. The control lines CI are dedicated to a group of senders and may only be used by this group. Accordingly, the control interconnect is modular and comprises basically the same structure as the data network. In addition, by bypassing the switch logic, the control interconnect will not be subject to the latency penalties of the switches SW. As the data is transferred between the senders and the receiver via the network, the path taken by the data to be transmitted may be different from the path of the control interconnect. Preferably, the control lines CI are set up when a connection is initiated such that they may only be used in this particular configuration for the connection. If a further connection is initiated, the control lines may have a different configuration.

FIG. 3 shows a block diagram of an electronic device with a control interconnect according to a second embodiment. Here, four senders S0-S3 and a single receiver R are shown. The senders S0-S3 and the receiver R are coupled by a request line RL and a grant line GL. As several senders are coupled to the request line RL and the grant line GL, some means of arbitration is required to assign the request line RL and the grant line GL to one of the senders. Therefore, the second sender S1 will be coupled to the request line RL and the grant line via a first control circuit CC1. The second and third sender will be coupled to the request line RL and the grant line GL via a second and third control circuit CC2, CC3, respectively. Accordingly, the request signals from the senders, i.e. req0-req3, as well as the grant signals gr0-gr3 are forwarded via the request line RL and the grant line GL.

In FIG. 3, a distributed control is depicted. Each sender S0-S3 can monitor the request line RL. If the request line RL is available, a sender S0-S3 may send a request signal req0-req3. If the grant signal gr0-gr3 arrives, the sender S0-S3 which has initiated the request signal req will send a number of data packets to the receiver R. However, as the sending of the request signal req from one sender to the next sender over the control interconnect may require multiple clock cycles, the request lines RL are always forwarded from one sender to the next, in particular in case of a conflict. When a grant signal is received, it is forwarded to the sender for which the request was selected. Such an arbitration control is simple to implement. On the other hand, this arbitration control does not constitute a fair arbitration. The sender closest to the receiver may not forward the grant line or grant signal to another sender if the grant line GL is high (such that a data transfer can be issued) and the sender wants to perform a data transfer as well. However, if the (raised) grant line is forwarded, the other senders may think that they are allowed to perform a data transfer.

FIG. 4 shows a block diagram of a control circuit of a sender according to FIG. 3 according to a third embodiment. The control circuit CC comprises an arbiter unit AU and an arbiter state flip flop ASF and several logical units LU1, LU2, LU3.

The control circuit according to FIG. 4 is designed to determine whether a sender needs to bypass a grant signal gr or whether the sender may use the grant signal gr for itself and to start the data transfer of the transaction. The control circuit CC receives the request and grant signals req 0, gr 0 from a first and a second sender S0, S1 and receives a grant signal gr from the next control circuit while a request signal req is output to the next control circuit CC.

The first logic unit LU1 is implemented as an OR unit and receives the request lines req0, req1 from the first and second sender. The output of the first logical unit LU1 is forwarded as a request signal req to the next mode or sender. The second logical unit LU2 is implemented as an AND unit and receives a grant signal gr from the next mode or sender and the output of the arbiter state flip-flop ASF. The output of the second logical unit LU2 corresponds to the grant signal gr1 for the second sender S1. The third logical unit LU3 is implemented as a AND unit and receives the grant signal gr from the next sender and the output of the arbiter state flip-flop ASF. The output of the arbiter state flip-flop ASF is inverted and the output of the third logical unit LU3 corresponds to the grant signal gr0 of the first sender S0.

According to the third embodiment, the flow control is implemented by distributed control based on time slots. A sender will only then send a request signal req if the request signals req from senders which are arranged before the current sender on the control interconnect reaches the actual sender to avoid any interference. Accordingly, each sender will send a request req only at a specific time slot and the time slots across all senders are synchronized.

If a simple weighted decentralized arbitration is used based on the control circuit according to FIG. 4, a fair arbitration can be ensured. However, several counters are required at the sender to account for the necessary time slots.

Alternatively, a distributed flow control based on a rate control may be implemented. The request signals req from each sender allow a rate of operation.

Alternatively, a FPGA control can be implemented. Several sets of request and grant line RL, GL may be used. The control interconnect across the senders may be re-configurable.

FIG. 5 shows a block diagram of a control circuit for a receiver according to a fourth embodiment. The control circuit RCC comprises a buffer B, a control circuit unit CCU and a packet counter PCU. The request line RL and the grant line GL are coupled to the control circuit unit CCU. The data packets dp of the transaction can be received by the buffer B.

The receiver R sends a grant signal gr in response to a request signal req if sufficient buffering is available, in particular if sufficient buffering is available to accommodate the maximum amount of data requested by the sender. The receiver control circuits RCC is preferably arranged in front of the receiver R. The control circuit unit CCU keeps track of any outstanding grant signals gr which have been transmitted from the receiver control circuit. Furthermore, the control circuit unit CCU keeps track of the space in the buffer B. Here, the senders may send a guaranteed throughput packet on an available TDMA time slot after it receives a grant signal gr from the receiver R via the control interconnect CI. The maximum amount of data or the maximum number of packets which can be transmitted by the sender when receiving a grant may be predefined, may be configurable using a register, or may be a user specified parameter. Similarly, the amount of buffer space or the number of packets requested by a transmitter may be predefined, configurable using a register in the receiver, or may be provided as a parameter as part of the request using additional signals.

Alternatively, the receiver sends a grant signal as well as the specified time slots at which the sender can start sending the data if it has received a respective request signal from the sender and if sufficient space is available in the buffers B. In this case, the control circuit must ensure that not only sufficient space is available in the buffer but that also sufficient space is available in the buffers when the data from the sender is expected to arrive at the receiver. Accordingly, the control circuit needs to introduce temporal information with its operation.

However, to communicate the grant signal as well as the time slot values of the respective time slots, additional wires are required. Furthermore, the receiver must maintain the information on the time slots. The actual network-based interconnect for transferring the data can be over-designed in order to allow the senders to send in several possible time slots.

According to a further embodiment of the invention, the control information and the data transfer may be pipelined. The control circuit may start with the processing of the next set of request signal if the sender is transferring data over the network-based interconnect. The request signals can also be speculatively transmitted for guaranteed throughput and best effort packet in order to hide the latency.

Furthermore, if a computation like an image processing application is started within one of the communication blocks BL1-BL4, it may be expected that this communication block may need to transfer data after a specified time interval. Here, the sender may speculate/anticipate that the data transfer will take place within a specified time interval and may send a request signal req before it receives data from the communication block. In addition, a history-based prediction mechanism may be incorporated in the speculation on data transfers .

FIG. 6 shows a block diagram of a network on chip according to a fifth embodiment. Here, IP blocks IP are coupled to a network N via a network interface NI. The network N comprises a plurality of switches SW. The network interfaces NI may serve as senders and receivers of a data transfer. Here, two receivers R1, R2 are provided. In addition to the network based on the switches SW, a control interconnect CI is also implemented as wires. Preferably, these interconnect wires C11, C12 arc adapted to the structure of the on-chip network.

The above described end-to-end flow control enables a lower buffering requirement as known credit-based flow control schemes. Furthermore, the wiring overhead is reduced. This is because grant and request signals are only required for the network interfaces NI and not for the individual IP blocks acting as sender or receiver which are coupled to the network interfaces NI. The scalable network-based interconnects for data transfer are combined with an efficient flow control with a bus-based interconnect. The flow control mechanism is implemented de-centralized with a very low control hardware overhead. The latency of the data transfer can be reduced by means of pipelining and by look-ahead mechanisms.

While the amount of buffering is reduced, the latency required to access the data network is increased. The amount of buffering required can be traded-off with the latency penalty incurred before a sender gets access to the data network.

FIG. 7 shows a representation of a receiver according to a sixth embodiment. Here, the receiver comprises a single buffer for all of the data traffic from several senders S1-S4. The receiver should comprise buffers to account for a mismatch between the operating frequency of the network and the operating frequency of the receivers as well as for accounting for a congestion in the network as the data network may require an arbitrary amount of time to transmit data, in particular for best effort BE packets. By implementing this pipelining, the time delay caused by the handshake mechanism can be hidden. If guaranteed throughput GT packets are to be transmitted, the request signal req can be transmitted ahead of the time slots at which the sender is able to forward the data.

The principles of the invention can be implemented in a network-based communication system. The communication may be between several circuits boards, several chips in an electronic device, i.e. chip-to-chip interconnect, or a connection between several components on a single chip (on-chip networks).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be construed as limiting the scope of the claims.

1. Electronic device, comprising:
at least one sender (S0-S3) for transmitting data,
at least one receiver (R) for receiving data,
a network-based interconnect (N) for coupling the at least one sender and the at least one receiver such that a data traffic from the at least one sender is forwarded to the at least one receiver, and
at least one separate shared dedicated control interconnect (CI) coupled between the at least one sender (S0-S3) and the at least one receiver (R) for communicating flow control data between the at least one sender (S0-S3) and the at least one receiver (R).

2. Electronic device according to claim 1, wherein the flow control is based on a handshake mechanism with a request signal which is answered by a grant signal, and
wherein the control interconnect (CI) comprises at least one request line (RL) for the request signal (req) and at least one grant line (GL) for the grant signal (gr).

3. Electronic device according to claim 2, wherein the network-based interconnect (N) comprises a plurality of switches (SW) which are coupled by a plurality of network lines (NL).

4. Electronic device according to claim 3, wherein the request line (RL) and the grant line (GL) is provided in addition to the network lines (NL).

5. Electronic device according to claim 1, wherein a control circuit (CC) is coupled to the control interconnect (CI) to the at least one sender and/or the at least one receiver.

6. Electronic device according to claim 4, wherein the control interconnect (CI) is adapted to the structure of the network-based interconnect (N) such that the control interconnect (CI) extends through the network (N) from the at least one sender (S0-S3) to the at least one receiver (R).

7. Electronic device according to claim 2, wherein the amount of buffer space or numbers of packets which are associated with a request is predefined, configurable or is specified as a parameter of the request signal.

8. Electronic device according to claim 2, wherein the amount of buffer space or the numbers of packets associated to a grant signal is predefined, configurable or specified as a parameter of the grant signal.

9. Electronic device according to claim 1, wherein the at least one receiver (R) comprises a buffer (B) which is used as a shared buffer for the communication with several senders (S0-S3).

10. Electronic device according to claim 2, wherein the request signals are processed in a pipelined manner.

11. Method of end-to-end flow control in an electronic device comprising at least one sender and at least one receiver, wherein the sender and the receiver are coupled by a network-based interconnect, comprising the steps of:
transmitting data from the at least one sender (S0-S3),
receiving data by the at least one receiver (R), wherein a data traffic is enabled by the network-based interconnect (N) from the at least one sender to the at least one receiver,
wherein the flow control data between the at least one sender (S0-S3) and the at least one receiver (R) is forwarded via a separate shared dedicated control interconnect which is coupled between the at least one sender (S0-S3) and the at least one receiver (R).

12. Data processing system, comprising:
at least one sender (S0-S3) for transmitting data,
at least one receiver (R) for receiving data,
a network-based interconnect (N) for coupling the at least one sender and the at least one receiver such that a data traffic from the at least one sender is forwarded to the at least one receiver, and
at least one separate shared dedicated control interconnect (CI) coupled between the at least one sender (S0-S3) and the at least one receiver (R) for communicating flow control data between the at least one sender (S0-S3) and the at least one receiver (R).
